(19) United States
(12) Patent Application Publication
(10) Pub. No.: US 2025/0037604 A1
(43) Pub. Date: Jan. 30, 2025

(54) SYSTEM AND METHOD FOR IMPROVING A STUDENT'S READING SKILLS

(71) Applicant: Objective Ed, Inc., Wellington, FL (US)

(72) Inventors: Martin Schultz, Miami Beach, FL (US); Luke Voelk, Harvard, MA (US); August Voelk, Harvard, MA (US)

(21) Appl. No.: 18/782,173

(22) Filed: Jul. 24, 2024

Related U.S. Application Data
(60) Provisional application No. 63/515,213, filed on Jul. 24, 2023.

(51) Int. Cl. G09B 17/00; G09B 5/06; G10L 13/08; G10L 15/26

(52) U.S. Cl. CPC G09B 17/006; G09B 5/06; G10L 13/08; G10L 15/26

(57) ABSTRACT

A system for improving a student's reading skills has a library of electronic books, a collection of settings that are specific to each student, a web-application for a student to use the system, a web-application browser for a teacher to adjust settings that are specific to each student, a natural language processing system to convert the student's oral speech into text, a natural language generation system to convert text into speech, and a database to store the student's oral speech, the converted text of the student's oral speech, and data relating to the student's performance while using the system.

### CROSS REFERENCE TO RELATED APPLICATIONS

This application claims the benefit of U.S. Provisional Application No. 63/515,213 filed on Jul. 24, 2023. The entire contents of this application are incorporated herein by reference in its entirety.

### FIELD OF INVENTION

The invention disclosed herein relates generally to a system and method for improving a student's reading skills, and more specifically to a system for improving a student's reading skills by analyzing an oral reading of a text input by the student by comparing short passages read by the student to a standardized version of the text being read.

### BACKGROUND OF THE INVENTION

Currently, students with a disability such as dyslexia, ADHD, autism, low vision, or other reading or learning disabilities, struggle to read, and have few options to independently improve their reading skills. Traditionally, students may co-read with their parent or teacher, alternating paragraphs: the student reads the first paragraph, the parent reads the second, and so on. However, this method suffers from the shortcoming that many parents and teachers do not have sufficient time to co-read with the student, some parents do not have the English language mastery to co-read, and some students may feel negatively judged by their parent as they co-read.

Alternatively, the student may use a read-along audio book whereby the student listens to the audio book as they silently read the corresponding words on the screen. However, this process suffers from the disadvantage that many students do not silently read as they listen to the audiobook, as their attention wanders. Additionally, parents or teachers cannot assess the student's improvement in reading skills without performing additional time-consuming assessments. Furthermore, there is no accurate measurement of the time the student spent reading. Most egregiously, if the reading mistakes are not tracked; the student can be making mistakes and they do not receive feedback to correct their mistakes and improve their reading skills, reinforcing poor reading habits.

Accordingly a system which overcomes the shortcomings of the prior art by removing the need of a parent or teacher co-reader and tracking the student's progress is desired.

### SUMMARY OF THE INVENTION

A system for improving a student's reading skills includes a web-based library of books, at least one book stored in the library. A first and at least a second portion of text are sourced from the at least one book. A text-to-speech converter communicating with the library to receive and convert the first portion of text into an audio output. An audiovisual display communicates with the text-to-speech converter to display the first and at least second portion of text and the corresponding audio output. An audio input receives a spoken word corresponding to an orally read version of the at least second portion of text of the audiovisual display. A natural language processor receives the audio input and converts the audio input into a third portion of text. A book processor receives the third portion of text and compares the third portion of text to the at least second portion of text.

A method for improving a student's reading skills includes the steps of selecting a digital book from a library of books and converting at least a first portion of text from the book into a first audio output. The first portion of text and first audio output are displayed on a first audiovisual output, and the student observes the first portion of text and the first audio output. A second portion of text is displayed on the first audiovisual output, and the student performs a verbal reading of the second portion of text. The verbal reading of the second portion of text is converted into a third portion of text and a corresponding audio. The third portion of text and the corresponding audio of the verbal reading are stored.

A processor compares the third portion of text with the second portion of text and performs at least one of determining an accuracy and identifying a word or a phoneme that was incorrectly pronounced, added, or skipped by the student in creating the third portion of text.

In one embodiment of the invention, a data set corresponding to the accuracy of the third text can be displayed on a second audiovisual output.

In another embodiment of the invention, the system then can conduct a remediation process, wherein a computer plays a second audio output corresponding to the second portion of text read by the student while displaying the second portion of text on the first audiovisual output. The system then replays the verbal reading with the second portion of text displayed on the first audiovisual output, and then the student reads aloud the second portion of text a second time with the second portion of text displayed on the first audiovisual output. The second verbal reading of the second portion of text is converted into a fourth portion of text. The fourth portion of the text and corresponding audio of the second verbal reading are stored. The processor compares the fourth portion of text with the second portion of text and performs at least one of determining an accuracy and identifying a word or a phoneme that was incorrectly pronounced, added, or skipped by the student in creating the fourth portion of text.

In another embodiment of the invention, the system can display a text on the screen in the same manner to which the text was originally formatted in the digital book, and the computer displays (audially and visually) a portion of the text that corresponds to a single sentence, or multiple sentences or a paragraph.

In another embodiment of the invention, the system displays a text on the screen in a different manner to which the text was originally formatted in the digital book, breaking the text into a first and at least second smaller portion that allows for easier comprehension and reduced reading fatigue. The computer displays (audially and visually) the first smaller portion of the text, and the student observes the first smaller portion of text and audio output and performs a verbal reading of the at least firsts smaller portion of text; creating a second smaller portion of text.

In another embodiment of the invention, the system can personalize the book for the student by using an artificial intelligence to adjust character traits and story attributes. The artificial intelligence scans for patterns between the student's reading and a data set of other students to provide individualized recommendations based on where the student struggles. The artificial intelligence recommends other books in a series for the student to read or a different series if the current series is too difficult for the student.

### BRIEF DESCRIPTION OF THE DRAWINGS

The present disclosure is better understood by reading the written description with reference to the accompanying drawings and figures in which like reference numerals denote similar structure and refer to the elements throughout, in which:

FIG. 1 is a schematic diagram of a system for learning to read online in accordance with the invention;

FIG. 2 is a flowchart presenting the steps for preprocessing a book in accordance with the invention;

FIG. 3 is an operational diagram of the system of FIG. 1;

FIG. 4 is a flowchart presenting the steps for collecting data in accordance with the invention;

FIG. 5 is a schematic diagram for displaying reading data in accordance with the invention;

FIG. 6 is a perspective view of a user interface in accordance with the invention;

FIG. 7 is a perspective view of an artificial intelligence interface in accordance with the invention;

FIG. 8 is a schematic diagram of a system for learning sounds associated with letters;

FIG. 9 is an operational diagram of the system of FIG. 8;

FIG. 10 is an operational diagram of a comprehension service constructed in accordance with the invention;

FIG. 11 is a schematic diagram of a vocabulary tester constructed in accordance with the invention;

FIG. 12 is an operational diagram of the book processing service constructed in accordance with the invention;

FIG. 13 is a method for learning a language in accordance with the invention;

FIG. 14 is an operational diagram of a system for learning a language in accordance with the invention;

FIG. 15 is an operational diagram of a system for learning a language in accordance with the invention;

FIG. 16 is an operational diagram of a system for learning a language in accordance with the invention;

FIG. 17 is an operational diagram of a system for learning a language in accordance with the invention;

FIG. 18 is a schematic diagram of a system for compensating for student fatigue constructed in accordance with the invention;

FIG. 19 is an operational diagram of a system for determining comprehension; and

FIG. 20 is an operational diagram of the system of FIG. 19.

### DETAILED DESCRIPTION OF THE PREFERRED EMBODIMENTS

The subject matter of aspects of embodiments of the present invention is described with specificity herein to meet statutory requirements. However, the description itself is not intended to limit the scope of any patent issuing from this description. Rather, the inventor has contemplated that the claimed subject matter might also be embodied in other ways, to include different elements or combinations of elements similar to the ones described in this document, in conjunction with other present or future technologies.

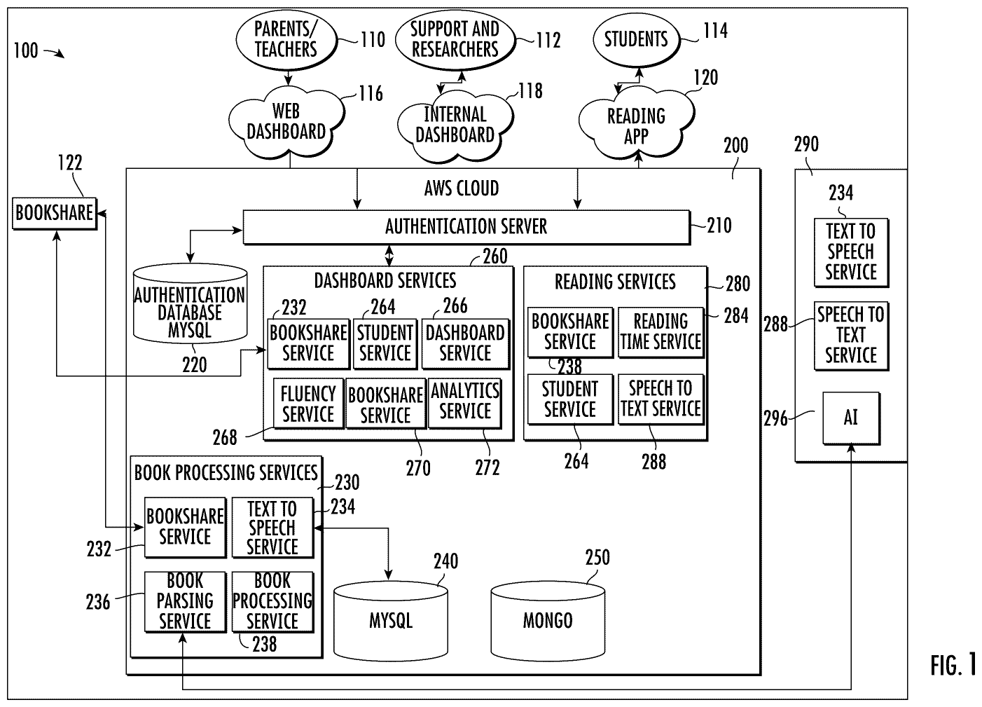

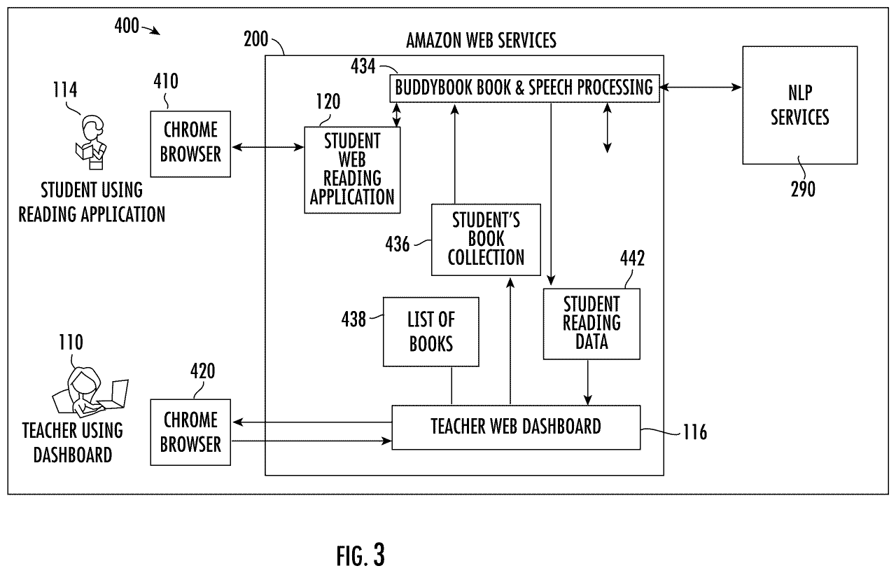

Reference is first made to FIG. 3, where an operational diagram of a nonlimiting preferred embodiment of the system for improving a student's reading skills is provided. A system 200 includes a student book collection 436, containing books selected by and/or for a student 114 from any available source, or created for the education system itself, for use from a bookshare library 122 (FIG. 1) as will be described below. A book and speech processor 434 receives the book in text format and, communicating with a natural language processor services 290, converts the book text into a spoken word file.

A Teacher Web Dashboard 116, accessible using a browser, such as Chrome browser 420, by way of nonlimiting embodiment, enables access to system 200 by a teacher 110 as will be described in greater detail below. A list of books 438 of books stored in bookshare library 122 is accessible by Teacher Web Dashboard 116. Teacher Web Dashboard 116 also communicates with student book collection 436 enabling teacher 110 to select a book from list of books 438 and download a selected book to student book collection 436.

In parallel, student 114 utilizing a browser 410, such as a Chrome browser in a preferred non limiting embodiment, communicates with a web-based student web reading application 120. Student web reading application 120 is in communication with a book speech processor 434.

As will be discussed in greater detail below, book speech processor 434, utilizing natural language processor services 290, communicates with student web reading application 120 to monitor text and speech outputs and inputs at browser 410 and create data sets about the student reading as a student reading database 442, which is input to Teacher Web Dashboard 116.

Reference is made to FIG. 1 in which system 100, for improving a student's reading skills in accordance with the invention is provided in greater particularity, including sub system 200. In a nonlimiting preferred embodiment, system 200 may be a cloud-based system, such as but not limited to AWS Cloud. Cloud-based system 200 which communicates with a library, such as Bookshare library 122 or the Gutenberg library, by way of non-limiting example. Bookshare library 122 acts as a library of books for use. Bookshare library 122 provides a collection of potential books to be used in operation of system 200.

Natural language processor services 290, such as but not limited to Microsoft NLP, is in communication with system 200 for converting speech to text and text to speech to be processed by system 200. Natural language processor services 290 includes a Text-to-Speech Service 234 for converting selected text from books stored in student book collection 436 into an audio output (speech). Natural language processor services 290 also includes Speech-to-Text Service 288 for converting input speech from student 114 to text to be used as described below. Natural language processor services 290 may also include an artificial intelligence-based processor for controlling each of Text-to-Speech Service 234 and Speech-to-Text Service 288 to maximize the accuracy of the conversions.

Teacher 110 or parent, preferably uses a web-based application to access Teacher Web Dashboard 116. Student 114 preferably uses a web-based application to access a Student Web Reading Application 120. A developer 112 can access system 100 through an Internal Dashboard 118. Teacher 110, student 114, and developer 112 preferably need to successfully access system 100 with an Authentication Server 210, which references an Authentication Database 220, in a preferred non limiting embodiment, to use system 100.

A Dashboard Services 260 provides book access and functionality to System 200 and includes a Student Service 264 for enabling student 114 to process books. A Dashboard Service 266 enables operation on selected books at Teacher Web Dashboard 116. A Fluency Service 268, receiving the input from student 114, determines the degree to which student 114 reads the selected text with proper speed, accuracy and expression. A Book Service 270, acting in cooperation with Bookshare Service 232, enables books stored in Bookshare library 122 to be selected and operated upon as described below. An Analytics Service 272 of dashboard services 260 enables analytic analysis of student's 114 inputs.

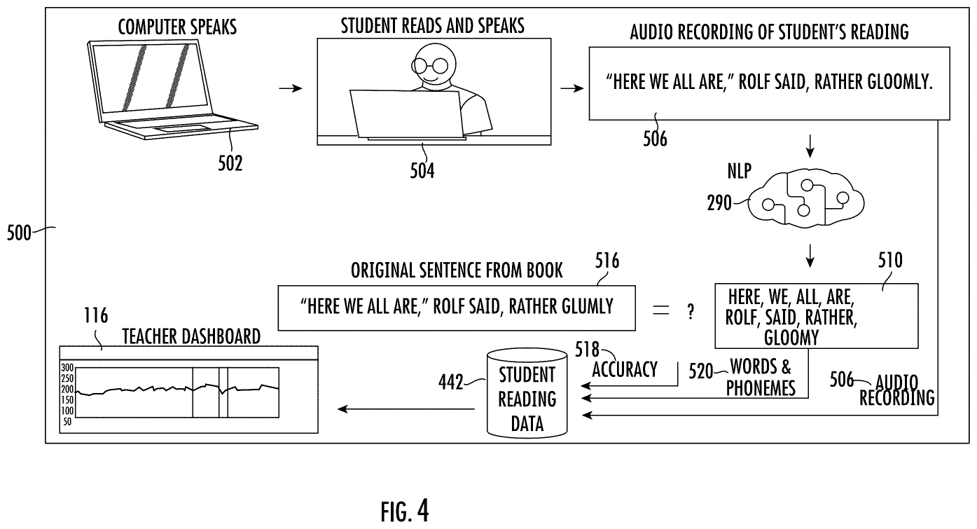

A Book Processing Services 230, operating on the books to be processed from Bookshare library 122, includes a Bookshare Service 232 communicating with bookshare library 122 for receiving a selected book for processing. A book processing service 238 working in cooperation with a Reading Services 280 and book share service 232 processes the text of books for use in system 200. Book Parsing Service 238 breaks the text of selected books into desired segments for processing and converts the text into speech by natural language processor services 290, including adjusting a selected reading passage size using boundary sentence disambiguation. Book Processing Services 238 further includes a Text-to-Speech Service 234 for converting a passage into an audio output 502 (FIG. 4), such as but not limited to computer generated human-like speech. Once books have been processed by book processing service 230, they are stored in a MySQL® database 240 and/or Mongo® database 250, by way of preferred non limiting embodiment. The passage and audio output 502 can be displayed on Student Web Reading Application 120. Within Reading Services 280, Speech-to-Text Service 288 can receive an audio input 506 (FIG. 4), preferably converted to a recording for processing, from student 114 reading aloud 504 and convert audio input 506 into a list of words 510 (FIG. 4).

System 200 also includes Reading Services 280 for operating on inputs from student 114. Reading Services 280 also includes Book Processing Service 238 for processing downloaded text for use by student 114. Reading services 280 operationally includes Speech-to-Text Service 288. A Time Service 284 determines the time period required for reading the text out loud by student 114, and a time period for an absence of any audio input to system 200.

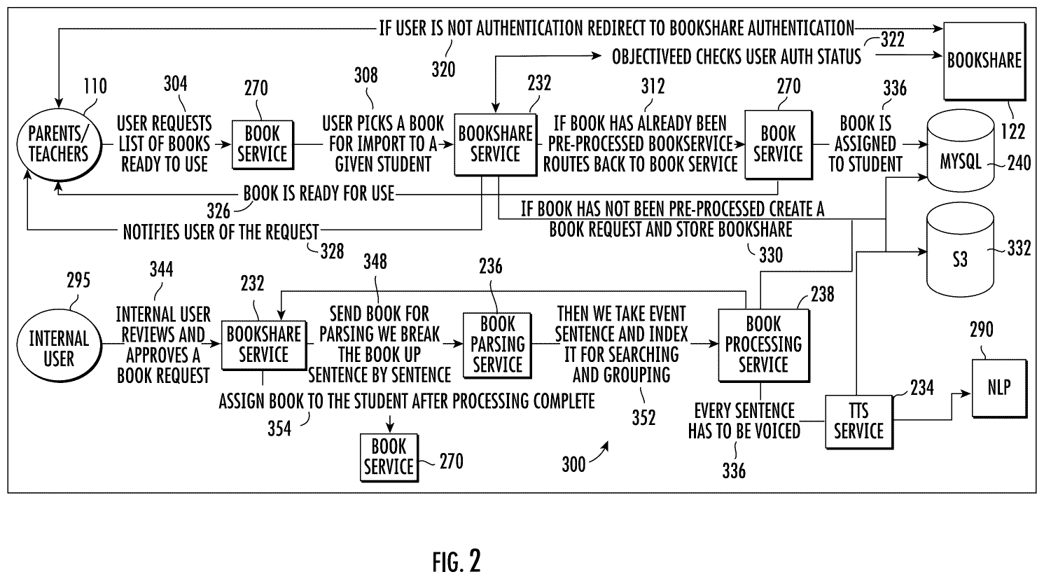

Again, as seen in FIG. 2 in one nonlimiting preferred embodiment, system 100 performs a preprocessing procedure 300 on a book. The digital content of the book is analyzed and converted using many forms, such as but not limited to ePUB, HTML, PDF, or text, to produce a book specific database that can be used for co-reading. Preprocessing procedure 300 utilizes Book Service 270 to allow teacher 110 to request a list of books ready for use in a step 304. Teacher 110 picks a book utilizing Bookshare Service 232 in a step 308, if teacher 110 is authorized to use the system as determined in a step 322. Confirmation is made of the request in a step 328 to teacher 110. If it is determined in a step 312 that the selected book has already been processed in a step 312, the book is assigned to student 114 in a step 316, from database 240 by book service 270.

If the book has been processed, Bookshare Service 232 will assign the book to student 114 at book service 270 in a step 354. If the book has not been processed, the book is sent for parsing, sentence by sentence in a preferred non limiting embodiment, by book parsing service 236 in a step 348. Books may be parsed by word or paragraph, by way of other examples. The parsed sentences are then each indexed, by book processing service 238, to enable searching and processing in a step 352. Book processing service 238 then causes the text to be stored in databases 332 or 240.

As part of processing, book processing service 238 causes each sentence of text to be voiced, converted to an audio output in a step 336. The text is converted to speech utilizing text to speech service 234 making use of natural language processor services 290. The speech is stored to be used as an audio output in databases 332 or 240.

Using Teacher Web Dashboard 116, teacher 110 can select a book from the list of books 438, such as but not limited to Bookshare library 122 or Gutenberg, based on student's 114 interests. Books can be categorized from the following, including but not limited to: grade level, topic, author, and similar parameters. Teacher 110 can download the book from list of books 438 and assign the book to student 114 by storing the book in Student Book Collection 436. A book can be listed in list of books 438 and assigned to student 114 if it is not preprocessed, but it will be added to a queue to undergo preprocessing procedure 300 as discussed above. During use, student 114 uses web-browser 410 to access student web reading application 120 enabling processing of a book stored in student's book collection 436.

Teacher 110 can use Teacher Web Dashboard 116 to adjust various settings, including but not limited to: the length of the co-reading process 500 (FIG. 4), the threshold on timeout, how much of a book can be presented to student 114, and how many of the presented sentences can be required to be read by student 114, and computer speaking speed. Student 114 uses web-browser 410 to access Student Web Reading Application 120 within cloud-based database 200. In Student Web Reading Application 120, student 114 can adjust various settings, including but not limited to: font color, font size, foreground color, background color, number of lines displayed, highlighting each word as system 100 speaks, using the computer mouse as a pointer while moving through a sentence, and speaking speed of system 100 when reading to student 114. Eventually, an artificial intelligence 296 will preferably vary the sentences dynamically to maximize student's 114 progress. Within Student Web Reading Application 120, student 114 can open a book selected by teacher 110 to begin co-reading process 500. To initiate co-reading process 500, Student Reader Application 120 can communicate with Bookshare 122 to request and receive the text and audio output 502 of the preprocessed book.

As seen in FIG. 4 in a nonlimiting preferred embodiment, system 100 preferably collects student reading database 442 while performing co-reading process 500. Student 114 can see the text and listen to audio output at an audiovisual display of a computer in a step 502 of a first portion of text from a passage from a book to be read. Each word in the passage read aloud by system 100 is displayed as system 100 plays the corresponding audio output of the text in step 502. An exemplary phrase may be “‘Here we all are’ Rolf said glumly”, displayed, but with no corresponding audio output. In this way, the system displays and audially outputs a first phrase, and then only visually displays a next passage, as text, for the student to read aloud.

While the computer plays audio visual output in step 502, Student Web Reading Application 120 displays a cue to student 114, such as “MY TURN.” Then, in turn, student 114 can read and speak the next phrase in a story in a step 504. Student 114 reads aloud in step 504; in this instance, student 114 mispronounces “glumly” as “gloomy” in a step 506. In a step 516 an audio recording of the input is stored in student reading database 442. In a step 510 natural language processor services 290 converts the student audio input into text. The converted text from step 510 is compared to the original text 516 and compared for accuracy in a step 518. The result is stored in student reading database 442.

The text from step 510 is also parsed into words and phonemes in a step 520 and stored in student reading database 442. Teacher Web Dashboard 116 accesses and displays the data stored in student reading database 442 for analysis. Student 114 can press “RETURN” or “ENTER” on the keyboard to inform the computer to speak again.

If student 114 does not begin to read in a specific timeframe, the computer asks student 114 if student 114 is participating. If student 114 confirms participation, the computer preferably re-reads its last sentence. If student 114 does not confirm participation, the computer then assumes the co-reading process 500 ended. This unique checkpoint encourages student 114 to remain actively engaged in co-reading process 500.

To determine timing between system outputs and student inputs, Student Web Reading Application 120 includes an internal clock to determine the time between output of a passage time and displays the amount of time remaining in co-reading process 500, in an area chosen by teacher 110 including but not limited to the upper right corner of the screen. Amount of time required can be set by teacher 110, and system 100 indicates the time requirement has been met. System 100 preferably begins counting time when it reads the first sentence to student 114, and system 100 preferably stops counting when student 114 exits co-reading process 500 or fails to confirm participation. Student 114 can continue participating even if the time requirement is met. After finishing co-reading process 500, system 100 can give student 114 positive feedback, such as but not limited to graphics or audio words of encouragement. When student 114 finishes a chapter or book, system 100 can give student 114 additional positive feedback.

From above, it is shown that natural language processor services 290 can use Speech-to-Text Service 288 to convert audio recording 506 into list of words 510 corresponding to student's 114 spoken words. System 100 compares list of words 510 to original sentence from book 516 read by student 114 to determine if student 114 decoded and spoke original sentence from book 516 accurately 518. Mistakes, reading accuracy 518, list of words 510, audio recording 506, phonemes, and timing can be stored in student reading database 442, which can be viewed by teacher 110 in Teacher Web Dashboard 116.

Student Web Reading Application 120 transmits audio recording 506 to student reading database 442, which stores audio recording 506, stamina (how long student 114 reads, preferably measured in minutes), and student's 114 identity. Student reading database 442 is embodied, by way of example as MySQL database 240. Student Web Reading Application 120 parses student's 114 speech into list of words 510 and corresponding phonemes for each word. Book and speech processor 434 compares each word from list of words 510 to original sentence from book 516 to determine the accuracy 518 of student's 114 reading as a percentage of correctness. Accuracy 518 of student 114 is preferably stored in student reading database 442. Fluency of student 114, calculated by determining the number of correct words spoken per minute, can be stored in student reading database 442. This process can take place during co-reading process 500 or afterwards.

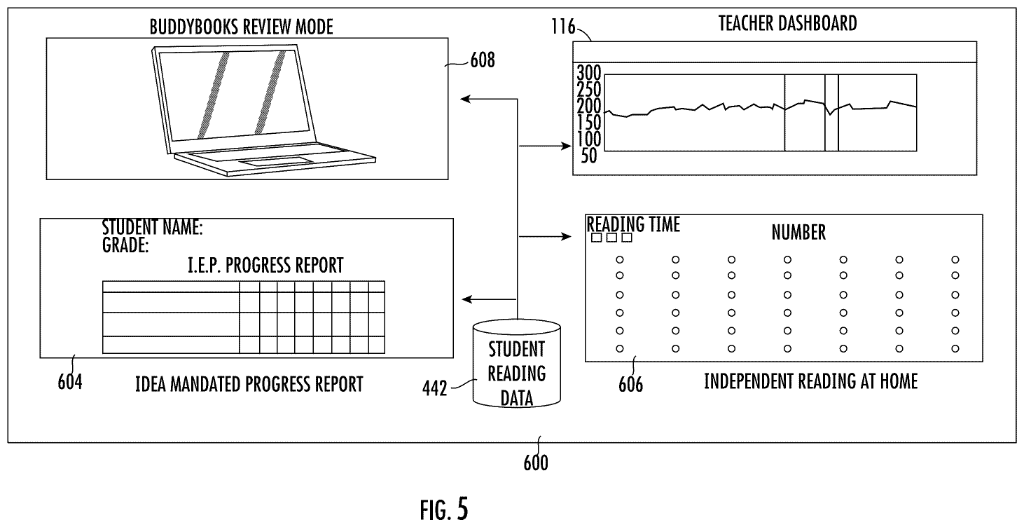

As seen in FIG. 5 in the first nonlimiting preferred embodiment, student reading database 442 can be used by teacher 110, student 114, or a third party, such as but not limited to a school district. Teacher Dashboard 116 preferably displays all data from co-reading process 500, such as but not limited to minutes per day, amount of book read, accuracy 518 of student 114, and specific words or phonemes that student 114 read incorrectly, added incorrectly, or skipped. Teacher Web Dashboard 116 also preferably indicates to teacher 110 if student 114 guessed at a pronunciation of a word. Student reading database 442 can be displayed in various forms, such as but not limited to a table, chart, or graph. The BuddyBooks Review Mode 608 uses student reading database 442 to select passages to review based on student's 114 struggles. Teacher Web Dashboard 116 uses student reading database 442 to help teacher 110 determine where student 114 needs additional practice. Teacher Web Dashboard 116 preferably allows teacher 110 to listen to audio recording 506, which allows teacher 110 to understand the prosody of student 114. Student reading database 442 can be exported by the third party to complete an IDEA mandated progress report 604. Teacher 110 uses student reading database 442 to become informed when student 114 is not reading enough each day by referencing the Independent Reading at Home 606. Reading time per day in Independent Reading at Home 606 can be displayed on any time period, such as but not limited to a week or many months. Student reading database 442 preferably allows teacher 110 to locate phonemes most often mispronounced by student 114 and the sentences in which those words were mispronounced.

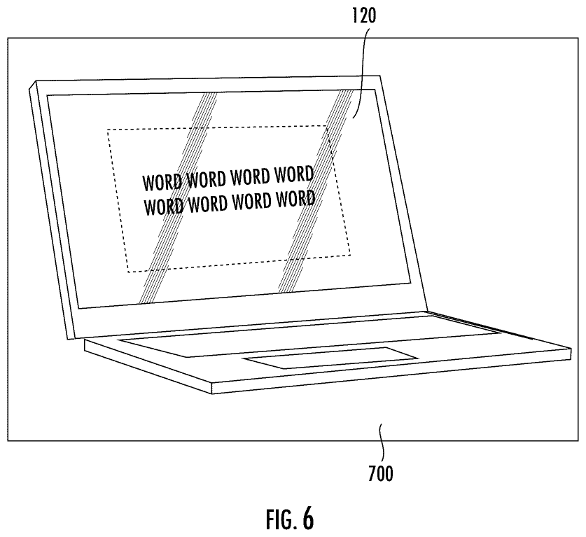

As seen in FIG. 6 in a nonlimiting preferred embodiment, Student Web Reading Application 120 can be configured by student 114 to create an organized interface by adjusting screen configuration and computer speaking rate.

Transitioning to the method, reference is brought back to the operational diagram in FIG. 3. A nonlimiting preferred method comprises a step of teacher 110 selecting a book from list of books 438. As seen in FIG. 2, the book preferably undergoes preprocessing procedure 300, where Book Parsing Service 236 breaks up the text of the book into smaller pieces 348 and natural language processing service 290 converts each smaller piece into audio output 502. To finish preprocessing procedure 300, teacher 110 preferably stores the book in Student Book Collection 436. Through Student Web Reading Application 120, student 114 initiates an additional step comprising the launch of co-reading process 500. By doing this, system 100 displays the smaller pieces of text on Student Web Reading Application 120.

In one nonlimiting preferred method, student 114 can participate in a remediation process. Preferably before beginning co-reading process 500, Student Web Reading Application 120 can request and receive at least one passage previously read by student 114. System 100 indicates to student 114 any mispronunciation, guess of a word, added word, or skipped word. In the first mode, model-reading, Student Web Reading Application 120 reads aloud original sentence from book 516 while displaying the corresponding words; the words can be highlighted. In the second mode, self-monitoring, Student Web Reading Application 120 preferably requests and receives audio recording 506. Student Web Reading Application 120 plays audio recording 506 and displays list of words 510; each word in list of words 506 is preferably highlighted as it is read. Student Web Reading Application 120 asks student 114 to perform a second reading of the original sentence from book 516. Student's 114 second reading can be sent to student reading database 442 for storage and processing.

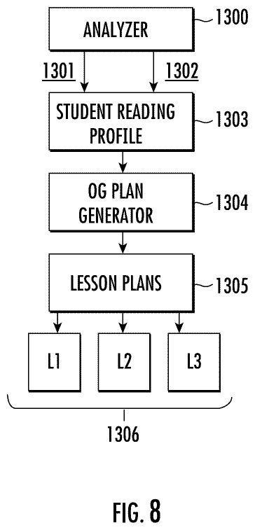

Reference is now made to FIG. 8 in which another non limiting embodiment in which the system teaches readers the connection between letters and sounds is provided. An Analyzer of Reading Problems 1300 receives student data from Student Reading Database 442, and as function thereof detects for the presence either one of two major categories of problems: Errors 1301 and Reading Ability 1302. Errors 1301 include, but are not limited to, Phoneme errors, decoding issues, sight word recognition problems. Reading Ability 1302 includes, but is not limited to, prosody, fluency, rhythm, stress intonation, reading speed. This information is stored in a Student Reading Profile 1303 and added to the data in Student Reading Database 442.

Using the Student Reading Profile 1303, an Orton Gillingham (“OG”) Lesson Plan Generator generates Lesson Plans 1305 as a function of the OG structured literacy approach, which consist of one or more Lessons Topics (L1-L3) 1306 to remediate the reading problems in the Student Reading Profile 1303.

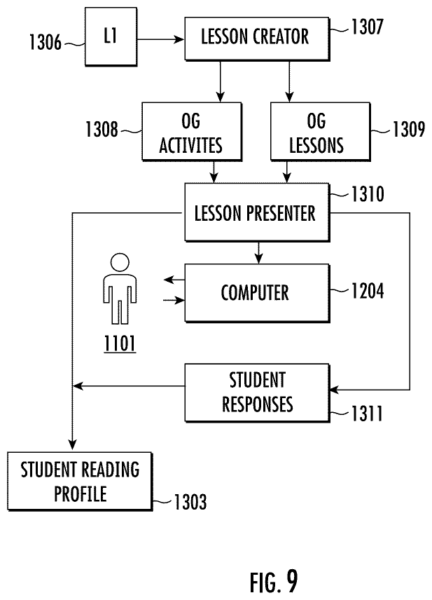

Reference is now made to FIG. 9 in which each Lesson Topic 1306 is processed by a Lesson Creator 1307. Lesson Creator 1307 generates OG activities 1308 and step-by-step OG Lessons 1309 as a function of lesson topics 1306. A Lesson Presenter 1310 presents OG activities 1308 and step-by-step OG Lessons 1309 as lessons 1312 on a computer 1204, used by the student 1101. A student's responses to the OG activities and step-by-step OG Lessons are collected from the computer 1204. The inputs to computer 1204 are passed back to the Lesson Presenter 1310. The Lesson Presenter 1310 evaluates the student responses and generates feedback 1313 and delivers the feedback to the student 1101 utilizing computer 1204.

The Lesson Presenter 1310 stores the lesson 1312, the student's responses 1311 and corresponding feedback 1313 in a Student Reading Profile 1303.

In another non limiting embodiment, system 100, utilizing generative AI technology, analyzes the structure, content, plotlines, backstory(s), settings, protagonist(s)′ names, unique story elements, and other character names of a book. System 100 then uses this data to enable personalizing of the book chosen by teacher 110. Teacher 110 then uses Teacher Web Dashboard 116 to change the analyzed book. In one method, teacher 110 replaces the protagonist's name with student's 114 name and other characters' names with the names of student's 114 friends and pets. System 100 then uses artificial intelligence (“AI”) to regenerate the book, now including the adjustments made by teacher 110.

System 100 also uses generative AI technology to regenerate the selected book at a different reading level. This allows student 114, by way of nonlimiting embodiment, to read an eighth-grade level book at a third-grade level by way of non limiting example.

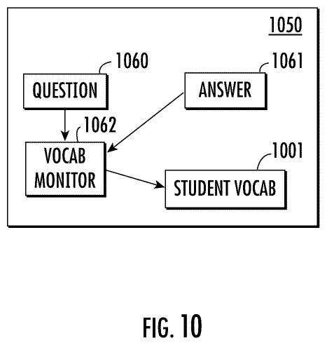

As seen in FIGS. 10-12, in another non limiting embodiment, system 1000, utilizing the data in student reading database 442 and as a function of analytical processing of this reading data, determines the student's vocabulary knowledge and growth over time. This is determined as a function of determining what words the student 1101 read correctly, what words the computer read to the student, and determining what words the student 1101 may understand and what words the student 1101 may not understand and stores this in the Student Vocabulary Database 1001.

Determining the student's vocabulary knowledge and growth over time is accomplished as part of several processes. Determining the words that the student may or may not have spoken correctly is performed during the speech-to-text analysis 288, by converting the text words and phonemes 520 and comparing those words to the original sentence from the book 516 to determine the accuracy 518 as described in FIG. 4.

Which words that the computer has read to the student is determined as the computer 501 speaks those words.

Specifically referring to FIG. 10, a system 1050, is a comprehension service that determines what words the student 1101 may understand and what words the student may not understand.

In one non limiting embodiment, question generator 1060 will generate a question, such as a comprehension question. The question is output at a computer display and input to a Vocab monitor 1062. The student answers the questions in a format such as multiple choice, true/false, or a reply containing one or more sentences, using the keyboard or similar input device, or microphone to speak the reply. Answer 1062 is also input to vocab monitor 1062 and Vocab monitor 1062 determines the accuracy of answer 1061. If the student's answer 1061 is correct, the vocabulary monitor 1062 may increase the probability that the student 1101 understands all words in the question. The vocabulary monitor 1062 will pass this information to the Student Vocabulary Database 1001. If the student's answer is incorrect, the vocabulary monitor may decrease the probability that the student 1101 understands all words in the question. Again, the vocabulary monitor 1062 will pass this information to the Student Vocabulary Database 1001.

In one non limiting embodiment, student 1101 can select a word on the screen 410 and ask for its pronunciation or definition with a keyboard or mouse or voice commands. System 1050 will note the request for the specific word and pass this information to the Student Vocabulary Database 1001.

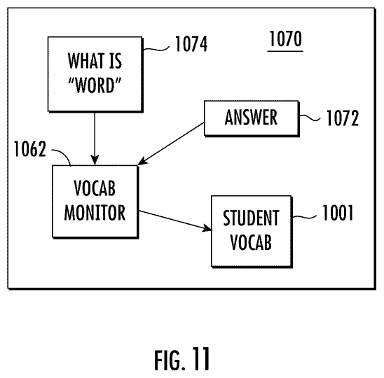

Reference is now made to FIG. 11 in which a further embodiment using a vocabulary tester is provided. A vocabulary tester 1070 will display a word on the screen 410, or speak the word, and request the student provide its definition of the word by providing “What Is’ word questions 1074 in a format such as multiple choice, true/false, or require one or more sentences. Using the keyboard or similar input device, or speaking the sentences, student 1101 provides an answer 1072. The answer 1072 and the question 1074 are input to Vocabulary monitor 1062. If the student's answer 1072 is correct, the vocabulary monitor 1062 may increase the probability that the student 1101 understands all words in the question. The vocabulary monitor 1062 will pass this information to the Student Vocabulary Database 1001. If the student's answer is incorrect, the vocabulary monitor 1072 may decrease the probability that the student understands all words in the question.

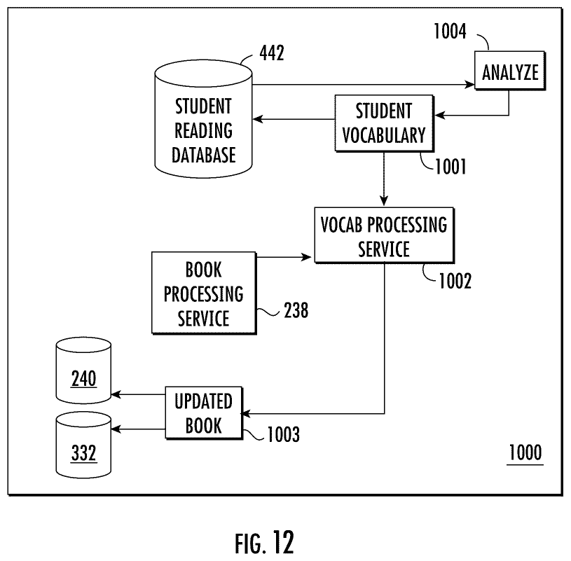

Reference is now made to FIG. 12 in which another embodiment of the invention is provided for operation of Book Processing Service 238. In this system 1000 in response to an output from Book Processing Service 238 a Vocabulary Processing Service 1002 to produce an updated book 1003 specific for the student. In this way specific words are changed as a function of inputs from a Student Vocabulary Database 1001 based upon changes in the data stored therein. Vocabulary Processing Service 1002 selects synonyms or expressions that match the word meaning when it is determined that the student may not fully understand or properly pronounce the word.

In a next embodiment of the invention the system will regenerate the book using alternative vocabulary to aid English as a second language students, or conversely assist English speaking students to read in a foreign language. The system will modify the book in a “Target”, second, language other than the “Source”, original, language of the book and present the book in both the Source language and the Target language.

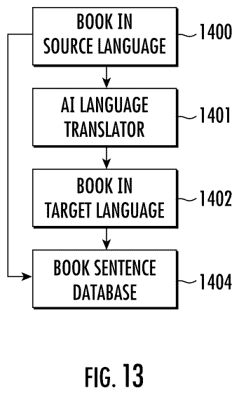

As seen in FIG. 13, the Book in the Source Language is operated upon. In a step 1400 Book in the Source Language is presented and is processed by an AI-based Language Translator in a step 1401 to produce the Book in the Target Language in a step 1402, one sentence at a time. As the Book is being translated each sentence of the source book is paired with its translated target language counterpart. Each sentence pair: (source language sentence and target language sentence) is stored in the Book Sentence Database in a step 1403.

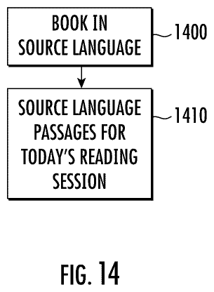

During implementation, as seen in FIG. 14, each day, the student will read one or more passages from the Book in the Source Language stored in step 1400. Those passages are considered the Source Language Passages to be used in for the Daily Reading Session in step 1410.

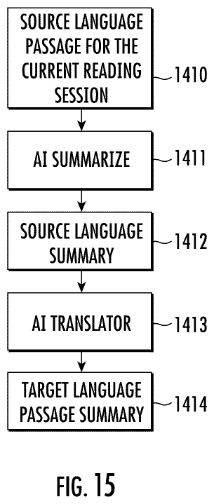

Reference is now made to FIG. 15, in which the method for processing the Source Language Book is provided. In a step 1410 the Source Language passages are selected for the daily reading session. In a step 1411 artificial intelligence may be used to take the Source

Language Passages for the Daily Reading Session and summarize the passages to create a Source Language Summary in a step 1412. AI Translator, using artificial intelligence in a preferred non limiting embodiment, will translate the Source Language Summary in a step 1413 as a Target Language Summary in step 1414.

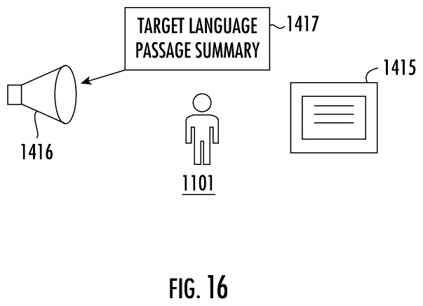

As seen in FIG. 16, at the beginning of a daily reading session, the Target Language Passage Summary 1417 is displayed on the computer screen 1415 and read aloud by the computer as an output of computer speaker 1416, so the student 1101 can both read the passage in the Target Language while listening to the passage in the Target Language.

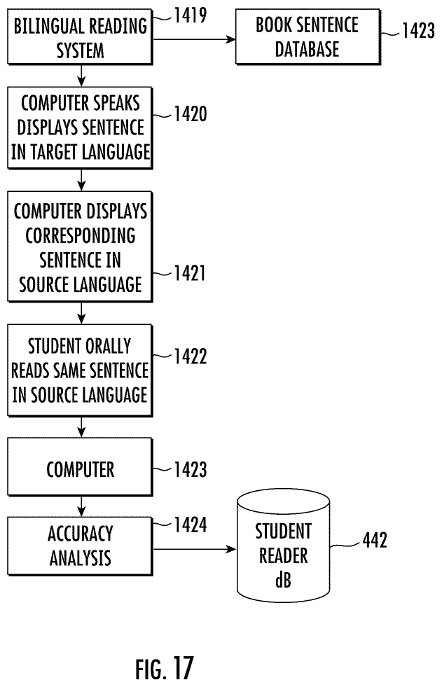

As seen in FIG. 17, for each sentence in the Book Sentence Database, a Bilingual Reading System 1419 takes a next sentence in both Source and Target languages from the Book Sentence Database 1423. The computer speaks and displays the Target language sentence 1420 on the screen as discussed above. The computer displays the corresponding Source language sentence 1421 on the screen. The student orally reads the Source language sentence (same as they student read/heard from the computer), and the computer 1423 records the student's oral reading, analyzes in the same manner described above, and stores the analysis in the Student Reading Database 442 for the other processes described above.

Alternatively, Bilingual Reading System 1419 can process sentences in asynchronous order. For example, the computer speaks and displays the Source Language sentence. However, in this non limiting embodiment, the next sequential Target Language text is displayed on the computer.

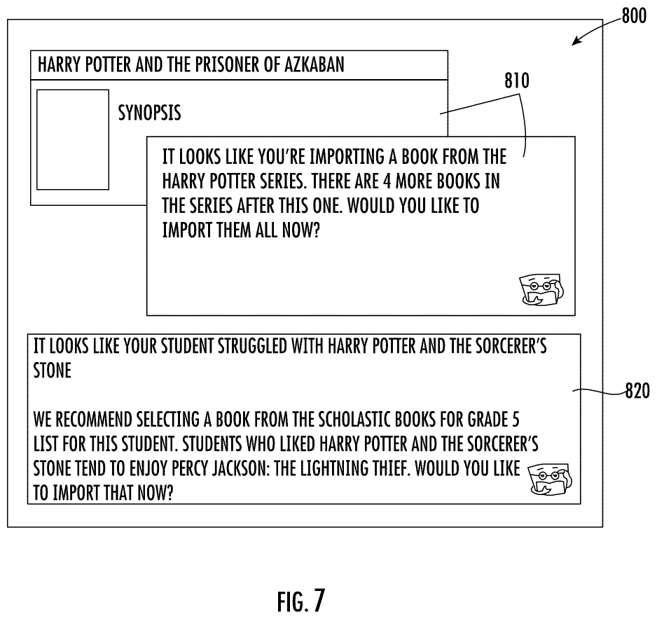

As seen in FIG. 7, another nonlimiting embodiment includes an Intelligent Book Picker (IBP) 800. IBP 800 is a rules-based AI architecture that improves the usability of Teacher Web Dashboard 116. IBP 800 analyzes data sets from thousands of students using system 100, which allows IBP 800 to provide recommendations, including best books, to help student 114 with specific reading problems.

IBP 800 creates rules based on patterns it spots in the data. When IPB 800 recognizes a pattern in student's 114 reading, matching a pattern addressed by a rule, IPB 800 triggers the rule and notifies teacher 110 of the best practices, such as but not limited to suggested books or specific workflows.

In one embodiment, IBP 800 recognizes decoding issues of student 114 and recommends changing attributes of student's 114 reading, such as shortening each passage assigned to student 114 and system 100 for alternate reading.

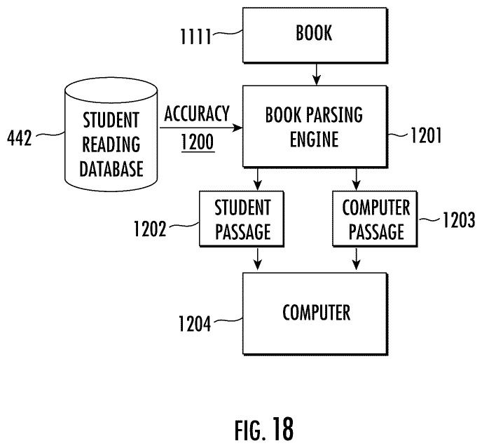

Reference is now made to FIG. 18 in which a non-limiting embodiment of the invention is disclosed. A Book Parsing Engine 1201 receives the text of Book 1111. Book Parsing Engine 1201 also receives data stored in Student Reading Database 442, such as reductions or improvements in student's fluency, pronunciation, or words skipped, together known as Reading Accuracy 1200. Book Parsing Engine 1111 parses the Book 1111 as discussed above, and will process the book 1111 differently as a function of the reading Accuracy 1200.

When the Book 1111 is initially processed by the Book Parsing Engine 1201, passages 1203 spoken by the computer 1204, and passages 1202 orally read by the student 1011, are about equal in length and presented to the student 1011 on a computer 1204. The teacher 1110 can provide inputs to Book Parsing Engine 1201 to adjust length of passage (1202,1203), where the passage may be one or more sentences, or one or more paragraphs. Or the teacher 1110 can provide inputs to Book Parsing Engine 1201 to adjust the length of the computer passage 1203 or the student passage 1202 to be of different lengths.

As a function of the data stored in the Student Reading Database 442, the Book Parsing Engine 1201 will dynamically adjust of the computer passage 1203 and the student passage 1202 to reduce reading fatigue or to challenge the student. Should the student's Reading Accuracy become worse, indicating reading fatigue, the Book Parsing Engine 1201 may shorten the student passage 1202 and may lengthen the computer passage 1203, thereby reducing cognitive load.

Conversely, should the student's Reading Accuracy become better, the Book Parsing Engine 1201 may lengthen the student passage 1202 and may shorten the computer passage 1203 to provide a more challenging task to the student.

The ratios between the student passage 1202 and the computer passage 1203, and length of student passage 1202, and the length of the computer passage 1203, and the underlying reasons and other relevant data indicating the reason the ratio or lengths are changed, are recorded in the Student Reading Database 442.

Additional embodiments promote student engagement, as IPB 800 recommends subsequent books in a series after student 114 reads one of the books in the series 810. If IPB 800 determines the book read was too difficult for student 114, IPB 800 recommends a similar series/genre with an easier grade level 820.

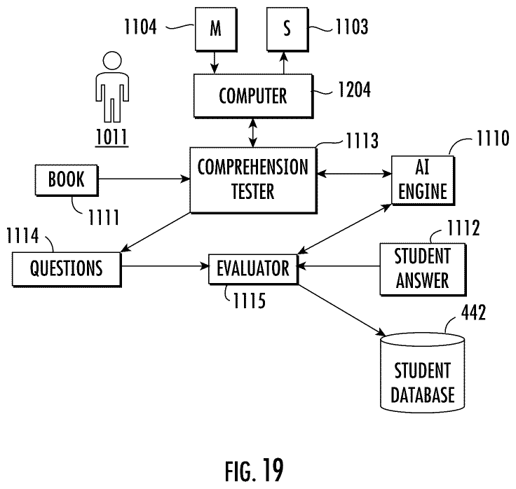

One method to determine if the book is too difficult for the student is to measure the student's comprehension of the book. As seen in FIG. 19, in another non limiting embodiment, system 1100, will determine the student's comprehension of the recent passages from the Book 1111 that the student read.

The Comprehension Tester 1113 will examine recent passages from book 1111 and using an AI engine 1110, will create a series of questions 1114 to ask the student 1101. In one nonlimiting embodiment, Comprehension Tester 1113 will employ questions based on the Socratic method. The computer 1102 will receive these questions 1114 from the Comprehension Tester 1113 in audio or written format and present them in written format on the computer screen, or audio format using the computer speaker or headphones 1103, to the student. The student will respond with the answer 1112, providing the answer in written format using the computer keyboard or speak the answer into the computer microphone. When the student answer is provided orally, the Comprehension Tester 1113 will convert the spoken answers 1112 into text. The Evaluator 1115 will use the AI engine 1110 to determine if the student's response correctly answers the question. The Comprehension Tester 1113 may generate variants of the questions 1114 using the AI engine 1110 or may generate other questions to determine the student's comprehension. The questions, student answers and correctness ratings will be stored with other Student Data in Student Database 442, available for the teacher to view in a dashboard 116.

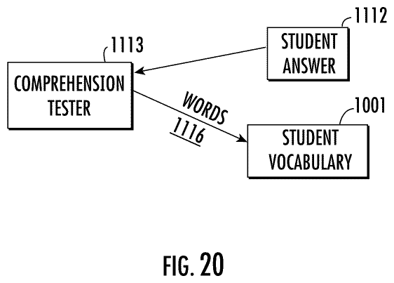

Reference is now made to FIG. 20 in which operation of the Comprehension Tester 1113 is provided. Comprehension Tester 1113 the answers form Student Answers 1112 and determines each of the words 116 that make up the sentences the student use in their Answers 1112 and stores each word and the frequency of word usage in Student Answer 112 in the Student Vocabulary 1001. This information will be used as part of the Auto-adjustment of the vocabulary of the story.

The foregoing description is considered as illustrative only of the principles of the invention. Further, since numerous modifications and changes will be readily apparent to those skilled in the art, it is not desired to limit the invention to the exact construction and process shown as described above. Accordingly, all suitable modifications and equivalents may be resorted to falling within the scope of the invention as defined by the claims that follow.

What is claimed is:

1. A system for improving a student's reading skills, the system comprising:
a web-based library of books;
at least one book, the at least one book being stored in the library of books; the book comprising at least one portion of text;
a first and at least a second portion of text from the at least one book;
a text-to-speech converter operatively coupled to the library of books, the text-to-speech converter converting the first portion of text to an audio output;
an audiovisual display communicating with the text-to-speech converter, the audiovisual display displaying the first portion of text, and outputting a corresponding audio output of the first portion of text, and displaying the at least second portion of text after the display of the output of the first portion of text;
an audio input for receiving a spoken word, the spoken word corresponding to the at least second portion of text of the audiovisual display; and
a natural language processor to convert the audio input of the spoken word into a third portion of text, the natural language processor comparing the third portion of text to the at least second portion of text from the at least one book in the library of books.

2. The system for improving a student's reading skills of claim 1, wherein the natural language processor compares the third portion of text with the second portion of text, and the natural language processor determining an accuracy for the third portion of text by identifying a word that was at least one of incorrectly pronounced, skipped or added.

3. The system for improving a student's reading skills of claim 1, wherein audiovisual display outputs the spoken word corresponding to the at least second portion of text while displaying the section portion of text on the audiovisual output; the audio input receiving a second spoken word, the second spoken word corresponding to the at least second portion of text; the natural language processor converting the audio input of the second spoken word into a fourth portion of text; and the natural language processor comparing fourth portion of text and second portion of text.

4. A system for improving a student's reading skills, the system comprising:
a web-based library of books;
at least one book, the at least one book being stored in the library of books; the book comprising at least one portion of text;
a first and at least a second portion of text from the at least one book;
a text-to-speech converter operatively coupled to the library of books, the text-to-speech converter converting the first portion of text to an audio output;
an audiovisual display communicating with the text-to-speech converter, the audiovisual display displaying the first portion of text, and outputting a corresponding audio output of the first portion of text, and displaying the at least second portion of text after the display of the output of the first portion of text;
an audio input for receiving a spoken word, the spoken word corresponding to the at least second portion of text of the audiovisual display; and
a natural language processor monitoring the audio input and creating student reading data sets as a function thereof;
a student reading database, the student reading data sets being stored therein as student data;
an analyzer communicating with the receiving the student reading database and determining the presence or absence of at least one of error and reading ability as a function of the student data.

5. The system for improving a student's reading skills of claim 4, wherein the presence or absence of at least one of error and reading ability is stored as a student reading profile; and further comprising an OG plan generator, receiving the student reading profile and generating at least one lesson topic as a function of the a student reading profile.

6. The system for improving a student's reading skills of claim 5, further comprising a lesson creator, the lesson creator receiving the at least one lesson topic and generating an OG activity and an OG lesson as a function of the at least one lesson topic; a lesson presenter receiving the OG activity and the OG lesson and presenting one or more OG activity and a step by step OG lesson at the audio visual display.

7. The system for improving a student's reading skills of claim 4, wherein error includes one or more of phoneme errors, decoding issues, sight word recognition problems.

8. The system for improving a student's reading skills of claim 4, wherein reading ability includes one or more of prosody, fluency, stress intonation, and reading speed.

9. A system for improving a student's reading skills, the system comprising:
a web-based library of books;
at least one book, the at least one book being stored in the library of books; the book comprising at least one portion of text;
a first and at least a second portion of text from the at least one book;
a text-to-speech converter operatively coupled to the library of books, the text-to-speech converter converting the first portion of text to an audio output;
an audiovisual display communicating with the text-to-speech converter, the audiovisual display at least one of displaying the first portion of text, and outputting a corresponding audio output of the first portion of text;
a question generator generating comprehension questions as a function of the first portion of text from the at least one book; the question being output at an audiovisual display;
an input for receiving an answer from a student in response to the question;
a vocab monitor communication with the question generator and the input and receiving the question and the answer and determining the accuracy of the answer as a function thereof.

10. The system for improving a student's reading skills of claim 9, wherein the question is a request to provide the definition a word in the first text portion.

11. A system for updating a book to improve student reading skills, the system comprising:
a web-based library of books;
at least one book, the at least one book being stored in the library of books; the book comprising at least one portion of text;
a first and at least a second portion of text from the at least one book;
a text-to-speech converter operatively coupled to the library of books, the text-to-speech converter converting the first portion of text to an audio output;
an audiovisual display communicating with the text-to-speech converter, the audiovisual display at least one of displaying the first portion of text, and outputting a corresponding audio output of the first portion of text;
an audio input for receiving a spoken word, the spoken word corresponding to the at least second portion of text of the audiovisual display;
a natural language processor monitoring the audio input and creating student reading data sets as a function thereof;
a student reading database, the student reading data sets being stored therein as student data;
a student vocabulary data base stores a probability that a student comprehends specific words;
a book processing service breaks the text of selected books into desired segments for processing, and converts the text into speech;
a vocabulary processing service communicates with the book processing service and the student vocabulary data base and in response to outputs form each of the book processing service and the student vocabulary data base edits the book as a function of the probability that a student comprehends specific words.

12. A system for improving a student's reading skills, the system comprising:
a web-based library of books;
at least one book, the at least one book being stored in the library of books; the book comprising at least one portion of text;
a first portion of text and at least a second portion of text from the at least one book;
an audiovisual display communicating with the text-to-speech converter, the audiovisual display at least one of displaying the first portion of text, and outputting a corresponding audio output of the first portion of text;
Comprehension tester generates comprehension questions as a function of at least the first portion of text from the at least one book; the question being output at an audiovisual display;
an input for receiving an answer from a student in response to the question;
an evaluator receiving the student answer and the question and determining whether the answer is correct and determining whether the first portion of text is understood by the student as a function thereof;

13. A method for improving a student's reading skills, the method comprising the steps of:
selecting at least one digital book stored in a library of books;
converting a first portion of text from the at least one book into a first audio output;
displaying the first portion of text and the first audio output on a first audiovisual output;
displaying a second portion of text from the at least one book on the first audiovisual output, the second portion of text being different from the first portion of text;
participating in a co-reading process by which the student produces a verbal reading of the second portion of text, the verbal reading then converted to a third portion of text and stored; and
comparing the second portion of text to the third portion of text.

14. The method of claim 12, the method further comprising the step of:
editing the at least one digital book as a function of the comparison of the second portion of the text and third portion of the text.

15. A method for improving a student's reading skills in a first language, the method comprising the steps of:
selecting at least one digital book stored in a library of books;
converting a first portion of text from the at least one book into a first audio output in a source language;
converting the first portion of text from the at least one book into a second portion of text and a second audio output in a target language;
displaying, at a display, the second portion of text and the second audio output in the target language in text and audio form while displaying the first portion of text in the source language; and
receiving as an oral input at a microphone, the oral input of the student corresponding to the first text as read.
